(19) United States
(12) Patent Application Publication
(10) Pub. No.: US 2024/0383749 A1
(43) Pub. Date: Nov. 21, 2024

(54) Synthesis gas production by reverse water gas shift reaction using carbon dioxide and pyrolysis-derived hydrogen

(71) Applicant: Molten Industries Inc., Oakland, CA (US)

(72) Inventors: Kevin A. Bush, Oakland, CA (US); Caleb C. Boyd, San Francisco, CA (US)

(21) Appl. No.: 18/663,536

(22) Filed: May 14, 2024

Related U.S. Application Data
(60) Provisional application No. 63/466,464, filed on May 15, 2023.

(51) Int. Cl. C01B 3/24; B01D 45/16; B01D 46/24; B01J 6/00; B01J 8/02; B01J 8/04; C01B 3/52; C01B 32/40; C09C 1/48

(52) U.S. Cl. CPC C01B 3/24; B01D 45/16; B01D 46/2407; B01J 6/008; B01J 8/0278; B01J 8/0285; B01J 8/0492; C01B 3/52; C01B 32/40; C09C 1/48; B01D 2273/20; C01B 2203/0266; C01B 2203/0415; C01B 2203/049; C01B 2203/0833; C01B 2203/1058; C01B 2203/1241; C01B 2203/1623

(57) ABSTRACT

Chemical systems and methods for synthesis gas (syngas) production relying on pyrolysis gases containing a pyrolysis carbon product and pyrolysis-derived hydrogen from a pyrolysis reactor that pyrolyzes a hydrocarbon feedstock. A high-temperature carbon separation mechanism separates the pyrolysis carbon product from the pyrolysis gases while maintaining their temperature above 800° C. A carbon dioxide source provides a gas stream primarily made up of a carbon dioxide gas. The hot pyrolysis gases containing pyrolysis-derived hydrogen and the carbon dioxide gas are sent to a reverse water gas shift reactor to react the pyrolysis gases with carbon dioxide to form the syngas. The syngas thus formed in the reverse water gas shift reactor can be used in many types of downstream systems and applications, including in reducing a metal oxide such as iron ore or other metal oxide to obtain a metal oxide reduction product. Recycling and heat exchange are provided for achieving further system efficiencies.

### CROSS-REFERENCE TO RELATED APPLICATIONS

This application claims priority from U.S. Provisional Patent Application No. 63/466,464 filed on May 15, 2023 and which is incorporated herein by reference for all purposes in its entirety.

### FIELD OF THE INVENTION

The present invention relates to the production of synthesis gas (syngas) using pyrolysis-derived hydrogen and carbon dioxide (CO₂). More specifically, it is directed at the integration of methane pyrolysis driven clean hydrogen production with a CO₂ waste stream and a reverse water gas shift reaction to produce syngas with a focus on heat integration and low electrical energy intensity.

### BACKGROUND OF THE INVENTION

Synthesis gas or syngas, a mixture of primarily hydrogen (H₂) and carbon monoxide (CO), has a wide range of potential applications in the industry, including in iron ore reduction and chemical production for hydrocarbons such as diesel, methanol, and oxo-alcohols. In iron reduction, syngas is used as a reducing agent to convert iron oxide (primarily Fe₂O₃) into iron (Fe) in a process called direct reduction of iron (DRI). The syngas reacts with the iron oxide to produce metallic iron, water vapor, and carbon dioxide (CO₂). This process is often used as an alternative to traditional blast furnace methods and can significantly reduce the carbon footprint of iron production.

Syngas can also be converted into liquid fuels such as diesel and jet fuel through a process called Fischer-Tropsch synthesis. This process involves the reaction of syngas with a catalyst to produce long-chain hydrocarbons, which can be further processed to produce diesel fuel. Syngas can also be used as a feedstock for the production of methanol, which is an important chemical used in various applications such as fuel, solvents, and chemical intermediates. The process involves reacting syngas with water to produce methanol and carbon dioxide. In oxo-alcohol production, syngas is used as a raw material for the synthesis of alcohols such as butanol and isobutanol. The process involves the reaction of syngas with an aldehyde to produce the desired alcohol.

However, current syngas production via coal gasification or steam methane reforming has a high CO₂ emissions intensity. Coal gasification produces syngas by reacting coal with oxygen and steam, which produces large amounts of carbon dioxide. Steam methane reforming produces syngas by reacting natural gas with steam, which also releases carbon dioxide. Both of these methods contribute to the emission of greenhouse gasses and increase the carbon footprint of syngas production. Therefore, alternative methods of producing syngas with lower CO₂ intensity, such as biomass gasification or carbon capture and storage (CCS), are being developed and researched.

The prior art discusses a number of alternatives that involve hydrocarbon pyrolysis and syngas production. For example, Published Patent Appl. US2014/0206779 to Lackner et al. proposes methods and systems that involve thermochemically decomposing a gaseous hydrocarbon stream in an oxygen-free environment to derive synthesis gas. The teachings of Published Patent Appl. US2021/0061656 to O'Neal et al. describe production of synthesis gas using reverse water gas shift and with the aid of pyrolysis. U.S. Pat. No. 9,834,440 to Kern et al. describes preparation of synthesis gas that deploys pyrolysis gas obtained from thermal decomposition of one or more hydrocarbons.

The prior art, however, does not provide for syngas production that uses pyrolysis and pyrolysis gases in an efficient manner. Specifically, the proposed approaches do not address heat integration and low electrical energy intensity.

### OBJECTS AND ADVANTAGES

It is an object of the invention to overcome the limitations of existing high carbon footprint methods of producing synthesis gas. Specifically, it is an object of the invention to provide systems and methods that properly integrate the available heat energy and reduce electrical energy requirements to permit better electrification of synthesis gas production that uses pyrolysis gases derived from pyrolysis of hydrocarbons.

It is the objective of the present invention to overcomes current challenges with the integration of hydrogen from water electrolysis with continuous synthesis gas production such as the need to compress, transport, and store hydrogen in order to output a continuous and high temperature feed of hydrogen.

Additionally, the present invention aims to decrease energy intensity over the current state of the art in order to decrease the usage of electricity and specifically renewable electricity.

Yet another object is to produce synthesis gas that can be used in many downstream applications, including use in an iron ore direct reduction furnace or for the creation of fuels such as methanol, olefins, and oxo-alcohols.

### SUMMARY OF THE INVENTION

The objects and advantages of the invention are provided for by a chemical system and a method for producing a synthesis gas primarily made up of hydrogen and carbon monoxide with an additional mixture of carbon dioxide and water. The chemical system and method, as well as the synthesis gas derived with them rely on a pyrolysis reactor that pyrolyzes a hydrocarbon feedstock into pyrolysis gases at a pyrolyzation temperature. Typically, the hydrocarbon feedstock includes either essentially methane or natural natural gas and the pyrolysis carbon product is solid carbon. The pyrolyzation temperature in the pyrolysis reactor is between 500° C. and 1,600° C. The pyrolysis gases mainly include a pyrolysis carbon product and a pyrolysis-derived hydrogen, where the pyrolysis carbon product is preferably fluidized out of the pyrolysis reactor as part of the pyrolysis gases.

The chemical system and method further provide a high-temperature carbon separation mechanism for receiving the pyrolysis gases from the pyrolysis reactor. The high-temperature carbon separation mechanism is a high-temperature cyclone or a high-temperature candle filter, or a combination of both. The function of high-temperature carbon separation mechanism separates the pyrolysis carbon product from the pyrolysis gases while maintaining their temperature above 80020 C. Furthermore, the high-temperature carbon separation mechanism separates the pyrolysis carbon product from the pyrolysis gases at a separation efficiency of over 60% by mass, and preferably even at over 90% by mass.

The chemical system and method further deploy a carbon dioxide source for providing a gas stream primarily made up of a carbon dioxide gas. The carbon dioxide source can be selected from among biogenic carbon dioxide sources and/or waste carbon dioxide sources. In some embodiments the carbon dioxide gas is pre-heated to a temperature above 300° C. or even to above 500° C.

Next, the chemical system and method provide a reverse water gas shift reactor to receive both the pyrolysis gases from the high-temperature carbon separation mechanism and the carbon dioxide gas from the carbon dioxide source. As noted above, the carbon dioxide gas can be pre-heated prior to being received in the reverse water gas shift reactor. The reverse water gas shift reactor reacts the pyrolysis gases with the gas stream of carbon dioxide to form the synthesis gas. Preferably, the synthesis gas contains over 40% hydrogen by volume and over 15% carbon monoxide by volume.

The synthesis gas formed in the reverse water gas shift reactor can be used in many types of downstream systems and applications, or it can be stored. There are numerous specific embodiments of the invention depending on the use of synthesis gas as well as overall conditions under which the synthesis gas is obtained.

The reverse water gas shift reactor can be designed for high temperatures. For example, it can be operated at a shift temperature above 800° C. Further, a nickel-based catalyst is used in the reverse water gas shift reactor for efficient operation. When designed for such high shift temperature operation the reverse water gas shift reactor can receive pyrolysis gases arriving from the high-temperature carbon separation mechanism and cool them with the carbon dioxide gas to a temperature below 1,200° C.

Preferably, the pyrolysis reactor is operated such that the pyrolysis carbon product is fluidized out of the pyrolysis reactor by the pyrolysis gases. This facilitates the transfer of pyrolysis carbon product to the high-temperature carbon separation mechanism and helps in the separation process. Many specific types of pyrolysis reactors can be used in the systems and methods of the invention. For example, the pyrolysis reactor can be a thermal pyrolysis reactor, a microwave pyrolysis reactor, a plasma pyrolysis reactor, a liquid metal containing pyrolysis reactor, a liquid salt containing pyrolysis reactor and a catalytic pyrolysis reactor. Further, it is preferable to operate the pyrolysis reactor to obtain a reaction yield of hydrocarbon feedstock to pyrolysis-derived hydrogen greater than 70%.

In some embodiments a heat exchanger is provided downstream from the reverse water gas shift reactor for transferring heat from the synthesis gas to the gas stream. This is an advantageous way of achieving the pre-heating of carbon dioxide gas in the gas stream. Another heat exchanger downstream from the reverse water gas shift reactor can be used for transferring heat from the synthesis gas to the hydrocarbon feedstock before the latter is supplied to the pyrolysis reactor. This is yet another advantageous way of using heat generated by the system.

Some embodiments have further elements or components positioned downstream from the reverse water gas shift reactor. These components can include a wet scrubber for removing contaminants from the synthesis gas. Other components can include a removal system for removing at least a portion of the mixture of carbon dioxide and water from the synthesis gas. Suitable removal systems can be embodied by one or more components selected from among flash separation systems, pressure swing absorber systems, thermal swing absorber systems and dehydration and carbon dioxide removal systems.

In another embodiment of the invention a control system is added for varying the ratio of hydrocarbon feedstock and the carbon dioxide gas in the gas stream. Further, the control system also varies the pyrolyzation temperature and the shift temperature in the reverse water gas shift reactor. Thus, the control system provides control over the relative composition of hydrogen, carbon monoxide, carbon dioxide and water in the synthesis gas.

The invention further extends to a method of obtaining synthesis gas in a reaction with pyrolysis gases that are obtained from the pyrolysis reactor that pyrolyzes the hydrocarbon feedstock at the pyrolyzation temperature. The method relies on the pyrolysis reactor to produce the pyrolysis gases made up primarily of the pyrolysis carbon product and the pyrolysis-derived hydrogen. The pyrolysis gases are fed from the pyrolysis reactor to the high-temperature carbon separation mechanism for separating out the pyrolysis carbon product while maintaining the pyrolysis gases at a temperature above 800° C. The method also provides the gas stream primarily made up of carbon dioxide gas obtained from the carbon dioxide source.

Both the pyrolysis gases arriving from the high-temperature carbon separation mechanism and the gas stream of carbon dioxide gas are received in the reverse water gas shift reactor. In the reverse water gas shift reactor the pyrolysis gases react with the gas stream to form the synthesis gas that primarily includes hydrogen and carbon monoxide and further includes a mixture of carbon dioxide and water.

An advantageous system combines obtaining the synthesis gas and also obtaining a metal oxide reduction product that is produced in a metal oxide reduction reaction with the synthesis gas. The system has the pyrolysis reactor for pyrolyzing the hydrocarbon feedstock into pyrolysis gases and the high-temperature carbon separation mechanism for separating the pyrolysis carbon product from the pyrolysis gases. The temperature of the pyrolysis gases in the high-temperature carbon separation mechanism is maintained above 800° C. The system has the carbon dioxide source that provides the gas stream of primarily carbon dioxide gas. This system also uses the reverse water gas shift reactor for receiving the pyrolysis gases from the high-temperature carbon separation mechanism and for receiving the gas stream from the carbon The synthesis gas is formed by reacting these inputs dioxide source. inside the reverse water gas shift reactor.

In addition, the system is equipped with a reduction furnace for receiving the synthesis gas and for running the metal oxide reduction reaction with a metal oxide and the synthesis gas. The metal oxide can be selected from the group including iron ore, tin oxide, lead oxide, nickel oxide, copper oxide, and cobalt oxide.

The system can be further equipped with a recycle loop for using a top gas from the reduction furnace. The recycle loop is configured for receiving the top gas from the reduction furnace, drying it and reinjecting the dried top gas into the system. The recycle loop can have a means for combusting the top gas to obtain high-temperature gases and, when these are reinjected into the system, they can be injected into the reduction furnace to add heat. Alternatively, the top loop can be configured to reinject the top gas into the synthesis gas for cooling before the reduction furnace receives the synthesis gas. It is further preferable for the recycle loop to act as a mechanism for recycling a stream of carbon dioxide from the top gas to the reverse gas shift reactor. Thus, recycled carbon dioxide forms carbon monoxide, which then forms carbon dioxide again and is recycled back to the reverse gas shift reactor to continue the cycle. This advantageous cycle is a closed loop of carbon dioxide with no external carbon dioxide emissions.

The system can also combust a portion of the synthesis gas prior to it entering the reduction furnace to create a high-temperature synthesis gas to thus add heat to the reduction furnace. Combustion also acts to convert any residual carbon soot or hydrocarbons to carbon dioxide and water. The water can be removed by drying and the carbon dioxide can be looped back to the reverse gas shift reactor to form carbon monoxide. In some embodiments, the recycle loop purifies the top gas to remove particulate matter and/or carbon dioxide and/or non-reducing gases.

In some embodiments the system has a control system for varying the ratio of hydrocarbon feedstock and the carbon dioxide gas in the gas stream. Further, the control system also varies the pyrolyzation temperature and the shift temperature in the reverse water gas shift reactor. Thus, the control system provides control over a carbon composition and a metallization factor of the metal oxide reduction product exiting the reduction furnace.

The system can be further equipped with heat exchangers for transferring heat. In some embodiments the heat is transferred from the pyrolysis carbon product to either the hydrocarbon feedstock, the metal oxide, a steam or a working fluid or a combination of these. In some embodiments the heat is transferred from the metal oxide reduction product to either the hydrocarbon feedstock, the metal oxide, a steam or a working fluid or a combination of these.

The present invention, including the preferred embodiment, will now be described in detail in the below detailed description with reference to the attached drawing figures.

### BRIEF DESCRIPTION OF THE DRAWING FIGURES

FIG. 1 is a schematic diagram of a chemical system for obtaining synthesis gas according to the invention

FIG. 2 is a flow diagram of the main steps performed in the process of obtaining synthesis gas according to the invention using the system of FIG. 1

FIG. 3 are molar concentration plots showing the progression of the RWGS reaction at a shift temperature of 1,200° C.

FIG. 4 shows preferred carbon monoxide sources for the gas stream of carbon monoxide gas required in the RWGS reaction

FIG. 5 is a schematic diagram of another chemical system for obtaining synthesis gas according to the invention

FIG. 6 illustrates an alternative embodiment of a portion of the chemical system of FIG. 5 that uses a heat exchanger for pre-heating carbon monoxide gas

FIG. 7A shows another embodiment of a RWGS reactor with additional elements that can be deployed by systems and methods of the invention

FIG. 7B illustrates another embodiment of a chemical system that deploys a control system for regulating overall operation and syngas production

FIG. 8A illustrates a system that deploys the syngas in a metal oxide reduction reaction performed in an iron reduction furnace

FIG. 8B illustrates a portion of the system of FIG. 8A with additional elements

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

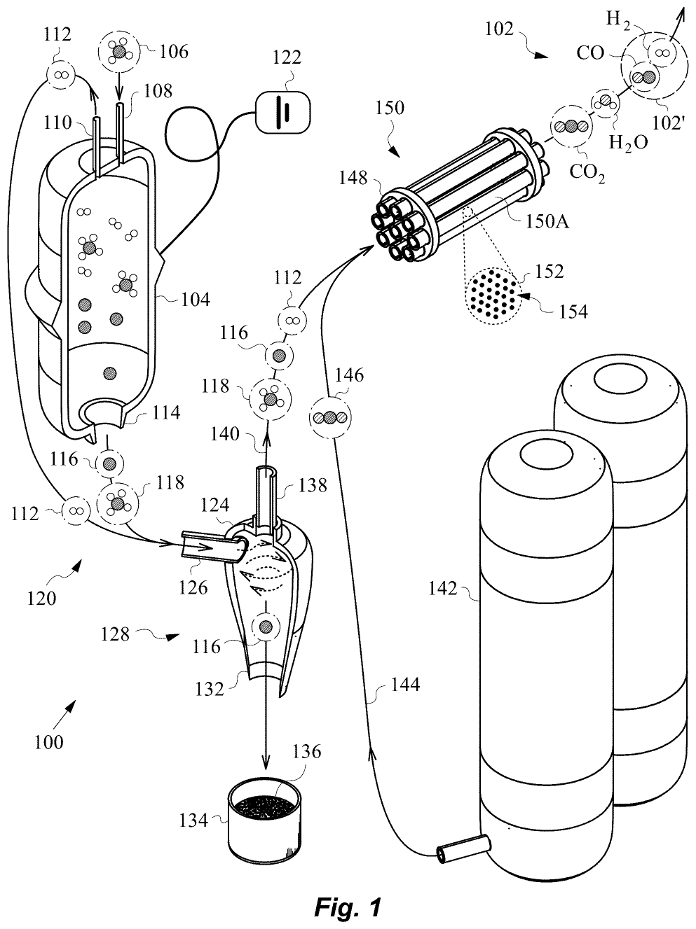

FIG. 1 is a schematic diagram a chemical system 100 for producing a synthesis gas 102, referred to as syngas by those skilled in the art and herein. Two main or primary components of syngas 102 are hydrogen (H₂) and carbon monoxide (CO) visualized in their highly magnified molecular form within a dashed outline 102′. Each primary component, i.e., hydrogen (H₂) and carbon monoxide (CO), is itself shown within dashed and dotted outline. Syngas 102 also contains an additional mixture of carbon dioxide (CO₂) and water (H₂O) each shown within dashed and dotted outlines.

Chemical system 100 has a pyrolysis reactor 104 for pyrolyzing a hydrocarbon feedstock 106 such as primarily or essentially methane or natural gas. In the present embodiment hydrocarbon feedstock is natural gas 106. Natural gas 106 is visualized in highly magnified molecular form by its most abundant component, methane (CH₄), within a dashed and dotted outline. Many specific types of pyrolysis reactors can be used. For example, pyrolysis reactor 104 can be a thermal pyrolysis reactor, a microwave pyrolysis reactor, a plasma pyrolysis reactor, a liquid metal containing pyrolysis reactor, a liquid salt containing pyrolysis reactor and a catalytic pyrolysis reactor.

Preferably, pyrolysis reactor 104 is a thermal, plasma or microwave driven reactor where natural gas 106 is thermally decomposed. Pyrolysis reactor 104 has an inlet 108 for admitting natural gas 106. Further, pyrolysis reactor 104 has a top outlet 110 for releasing pyrolysis-derived hydrogen 112. At the bottom, pyrolysis reactor 104 has a bottom outlet 114 for releasing a pyrolysis carbon product 116. Pyrolysis carbon product 116 in the present embodiment is solid carbon visualized in highly magnified molecular form within a dashed and dotted outline. In fact, pyrolysis reactor 104 should primarily decompose natural gas 106 into just pyrolysis carbon product 116 and pyrolysis-derived hydrogen 112.

Pyrolysis reactor 104 also releases a small amount of a hydrocarbon fraction 118. Hydrocarbon fraction 118 at bottom outlet 114 is principally composed of unreacted natural gas 106. Hence, it is also visualized in highly magnified molecular form within dashed and dotted outline by its most abundant component, methane (CH₄). More generally, however, hydrocarbon fraction 118 will consist of a variety of hydrocarbons such as methane, ethane, ethylene, acetylene, and aromatic hydrocarbons.

Together, pyrolysis-derived hydrogen 112, pyrolysis carbon product 116 and hydrocarbon fraction 118 constitute pyrolysis gases 120. In the present invention the most important components of pyrolysis gases 120 are pyrolysis-derived hydrogen 112 and pyrolysis carbon product 116. Thus, when pyrolysis gases 120 are referred to herein it will be understood that they contain at least these most important components. Furthermore, pyrolysis reactor 104 preferably operates so as to fluidize out pyrolysis carbon product 116 with pyrolysis gases 120.

Pyrolysis reactor 104 is connected to an electrical power supply 122 for heating pyrolysis reactor 104 to a pyrolyzation temperature between 500° C. and 1,600° C. Preferably, power supply 122 can generate a sufficient amount of power to reach pyrolyzation temperatures above 1,100° C. and thus drive pyrolyzation, also known as cracking or direct decomposition in an oxygen-free environment where hydrocarbons thermochemically decompose, without catalyst. At such pyrolyzation temperature the yield of methane in natural gas 106 fed into pyrolysis reactor 104 to pyrolyzation-derived hydrogen 112 can be in excess of 50%.

If the approach is catalytic, then ideally the pyrolysis temperature is at over 1,000° C. and pyrolysis carbon product 116 from pyrolysis reactor 104 will thus not be significantly contaminated with the catalyst material. However, when using catalysts pyrolysis temperature could be as low as 400° C. Typically, with catalytic pyrolysis the decomposition of natural gas 106 and hydrocarbons in general occurs on the surface of a catalyst particle and pyrolysis carbon product 116 adheres to the catalyst particle. If such adhesion takes place, this can lead to deactivation of the catalyst material and/or loss of the catalyst. Due to problems with the binding of pyrolysis carbon product 116 to the catalyst and the resulting contamination of the solid carbon with the catalyst, preferred embodiments avoid using a catalyst.

In embodiments that do use a catalyst it is preferable to choose elements from Group VIb and VIII of the periodic table. These include nickel, cobalt, iron, copper, noble metals, chromium, molybdenum, manganese, vanadium, alloys of these metals including steel, high-nickel alloys, or other common metal alloys, and even salts and oxides containing these metals. For non-catalytic operation, pyrolysis temperatures in excess of 1,100° C. are typically required to achieve higher yields of natural gas 106 to pyrolysis carbon product 116 and pyrolysis-derived hydrogen 112. And preferably, pyrolysis temperatures in excess of 1,200° C., and potentially as high as 1,800° C. are employed in pyrolysis reactor 104.

In the present invention, a large fraction, i.e., over 33% and preferably over 90% of solid carbon product 116 is fluidized out of pyrolysis reactor 104 with the outflowing pyrolysis gasses 120. Pyrolysis gasses 120 thus primarily consist of pyrolysis-derived hydrogen 112, solid carbon product 116 and small hydrocarbon fraction 118, as mentioned above. Also, in the present invention pyrolysis reactor 104 operates such that pyrolysis gasses 120 have a sufficient velocity to carry out the solid carbon particles of pyrolysis carbon product 116 from reactor 104, thus enabling a continuous process.

Chemical system 100 is further equipped with a high-temperature carbon separation mechanism 124 positioned for receiving pyrolysis gases 120 from pyrolysis reactor 104. High-temperature carbon separation mechanism 124 can be a high-temperature cyclone or a high-temperature candle filter. The last includes sintered candle filters designed to operate at high temperatures. High-temperature carbon separation mechanism 124 can also be made of a combination of one or more high-temperature cyclones in series and/or one or more high-temperature candle filters in series. In the embodiment shown in FIG. 1 high-temperature carbon separation mechanism 124 is embodied by a high-temperature cyclone.

High-temperature cyclone 124 is designed to operate at high temperatures. More precisely, the function of high-temperature cyclone 124 is to separate pyrolysis carbon product 116 from the pyrolysis gases 120 while maintaining their temperature above 800° C. Preferably, high-temperature cyclone 124 separates pyrolysis carbon product 116 from the pyrolysis gases 120 at a separation efficiency of over 60% by mass, and more preferably still at a separation efficiency of over 90% by mass.

In the present embodiment, high-temperature cyclone 124 has a peripheral cyclone inlet 126 for admitting pyrolysis gases 120 into its interior. Since pyrolysis gases 120, namely pyrolysis-derived hydrogen 112, pyrolysis carbon product 116 and hydrocarbon fraction 118 of unreacted natural gas 106, exit pyrolysis reactor 104 at temperatures above 1,000° C. cyclone 126 is a duly insulated, high-temperature cyclone. Preferably, steel or stainless steel piping that has a ceramic refractory lining is used to transport pyrolysis gases 120 from bottom outlet 114 of pyrolysis reactor 104 to cyclone inlet 126. Cyclone inlet 126 for receiving pyrolysis gases 120 is also preferably insulated and made of materials that can withstand the high temperature of pyrolysis gases 120. An interior chamber 128 of cyclone 124 is likewise insulated and made of materials that can withstand the high temperature of pyrolysis gases 120.

The design of high-temperature cyclone 124 for solid-gas separation is well understood by skilled artisans. Specifically, pyrolysis gases 120 undergo separation within interior chamber 128 of high-temperature cyclone 124 due to a vortex that produces a helical flow pattern indicated by the dashed arrows. More precisely, pyrolysis gases 120 enter high-temperature cyclone 124 and rotate around a central outlet pipe 130 at lower pressure. A majority of the large and heavy pyrolysis carbon product 116 drops out under gravity through a bottom outlet 132 of interior chamber 128.

Thus, pyrolysis carbon product 116 is separated from pyrolysis gases 120. A collection vessel 134 is positioned below bottom outlet 132 for collecting pyrolysis carbon product 116, which at this point is mostly composed of solid carbon 136. It is important to minimize the amount of pyrolysis-derived hydrogen 112 gas that is allowed to escape through bottom outlet 132. Therefore, collection vessel 134 into which solid carbon 136 is deposited is appropriately sealed with suitable elements (not shown). One option for such sealing is to use a dual cartridge load lock where solid carbon 136 is collected in parallel gas-tight load locks, which are alternately sealed and evacuated. The evacuated gas is used to refill the load lock to minimize loss of pyrolysis-derived hydrogen 112. Preferably, the loss of pyrolysis-derived hydrogen 112 from high-temperature cyclone 124 is kept below 5%.

Central outlet pipe 138 at the top of interior chamber 128 allows the remainder of pyrolysis gases 120 to exit high-temperature cyclone 124 in the form of a flow 140. Pyrolysis gases 120 exiting through central outlet pipe 138 at the top as flow 140 consist mostly of pyrolysis-derived hydrogen 112. However, they also contain a small amount of hydrocarbon fraction 118 composed of unreacted methane (CH₄) and a small amount of pyrolysis carbon product 116 that did not get separated in high-temperature cyclone 124. Although the amount of the last is small, FIG. 1 still indicates small amount of pyrolysis carbon product 116 that is present in flow 140 exiting through central outlet pipe 138.

The diameter of high-temperature cyclone inlet 126 and central outlet pipe 138 as well as the pressure drop through high-temperature cyclone 124 are key parameters in determining the separation efficiency. Separation efficiency is a measure of how efficiently solid particles are separated from the gas stream, in this case from the stream of pyrolysis gases 120 arriving from pyrolysis reactor 104. Typically, larger particles are much easier to separate than smaller particles. A series of high-temperature cyclones can be used to ensure separation of the majority of the solid carbon 136. It is noted that cyclone design parameters and optimization are well-known to those skilled in the art.

Specifically, in situations where high-temperature cyclone 124 is not able to separate out a sufficient amount of pyrolysis carbon product 116 from pyrolysis gases 120 by itself, additional cyclones are added in series with cyclone 124 (not shown). A sufficient number of cyclones should be provided to ensure a separation efficiency high enough for a majority of pyrolysis carbon product 116 to be separated out from pyrolysis gases 120. In particular, when pyrolysis carbon product 116 that is separated is mostly solid carbon 136, then preferably the at least one cyclone separates out over 60% up to and over 90% of pyrolysis carbon product 116 by mass from pyrolysis gases 120.

Perry's Chemical Engineers' Handbook, 9th Edition, Edited by Don Green and Marylee Southard has an excellent overview of the range of performance for cyclone dust collectors, which are one of the least expensive and simplest means of dust collection. Cyclone collectors are an affordable option for dust collection in terms of investment and operation within their performance range. However, most cyclones are not highly effective in collecting particles smaller than 5 to 10 microns.

In fluid catalytic cracking (FCC) units, third-stage separators (TSS) can achieve high efficiencies for particles as small as 2 microns. Typically, TSS units collect particles larger than 5 microns, while about 90 percent of the particles in the loss stream are smaller than 2 microns. Thus, in some embodiments the methane pyrolysis reaction in pyrolysis reactor 104 is controlled to produce particles of pyrolysis-derived carbon product 116 of sizes that are larger than 2 microns and preferably larger than 5 microns and more preferably larger than 10 microns. These particle sizes enable low-cost, high efficiency particle-gas separation using high-temperature cyclone 124 or a series of high-temperature cyclones.

It should be noted that while cyclones can collect particles larger than 200 microns, gravity settling chambers or simple inertial separators are usually sufficient and less prone to abrasion. However, in special cases where highly agglomerated dust or high concentrations over 230 g/m³ are encountered, cyclones can effectively remove small particles. In some instances, cyclones can achieve up to 98 percent efficiency with particles ranging from 0.1 to 2.0 microns due to particle agglomeration caused by strong interparticle forces. Thus, in some embodiments, a high dust loading >230 g/m³ is preferred to improve separation efficiency of particles <2 microns in size. Cyclones are capable of removing both solids and liquids from gasses, and they have been operated at temperatures as high as 1,200° C. and pressures as high as 500 atm.

Furthermore, cyclones come in various sizes, ranging from small diameters of approximately 1 to 2 cm to large diameters of up to about 10 m. The number of cyclones used in a fluidized bed can vary from 1 to as many as 22 sets, depending on the configuration. Cyclones can be installed internally or externally to a reactor, in horizontal or vertical orientation, in series or in parallel, and under pressure or vacuum conditions. Despite the numerous design variations, the fundamental gas-solid separation mechanisms remain similar and are familiar to those well-skilled in the art (see Perry's Chemical Engineers' Handbook, 9th Edition, Edited by Don Green and Marylee Southard, op cit.).

Flow 140 of pyrolysis gases 120 largely consisting of pyrolysis-derived hydrogen 112 and small amounts of unreacted hydrocarbon fraction 118 as well as some unseparated pyrolysis carbon product 116 is maintained at a high temperature. The specific temperature depends on the application as discussed in more detail below.

Chemical system 100 has a carbon dioxide source 142 for providing a gas stream 144 primarily made up of a carbon dioxide gas 146. The latter is visualized in highly magnified molecular form, within a dashed and dotted outline. In some embodiments a heating mechanism (not shown) is provided to pre-heat carbon dioxide gas 146 in gas stream 144.

A reverse water gas shift reactor 148, referred to herein as RWGS reactor, belonging to chemical system 100 is configured to receive both flow 140 of pyrolysis gases 120 from high-temperature cyclone 124 and gas stream 144 of carbon dioxide gas 146 from carbon dioxide source 142. Many types of RWGS reactors can be used. The embodiment of FIG. 1 illustrates RWGS reactor 148 with a number of tubes 150 for admitting flow 140 of pyrolysis gases 120 and gas stream 144 of carbon dioxide In the present embodiment tubes 150 are made of stainless gas 146. steel.

One of tubes 150, namely tube 150A is expressly referenced to show another feature of RWGS reactor 148 in an enlarged portion 152 of the inner wall of tube 150A. Enlarged portion 152 shows that inner wall of tube 150A is coated with a catalyst 154. Other tubes 150 are similarly coated on their inside walls with catalyst 154 (not shown). Additionally, tubes 150 can be filled with catalyst particles to promote the rate of RWGS reaction. Catalyst 154 is a nickel-based catalyst that promotes the rate of RWGS reaction. It is noted that providing catalyst 154 to catalyze RWGS reaction is not necessary at temperatures above 1,200° C., but becomes important at lower temperatures, and especially at temperatures below 1,000° C.

RWGS reactor 148 supports the RWGS reaction between pyrolysis gases 120 and gas stream 144 within its tubes 150. More precisely, the reaction involves pyrolysis derived hydrogen 112 contained in pyrolysis gases 120 and carbon dioxide gas 146 from gas stream 144. The reaction forms syngas 102 that is released from tubes 150 of RWGS reactor 148. Syngas 102 is made up primarily of hydrogen H. and carbon monoxide CO, but it also has an additional mixture of carbon dioxide CO. and water HO in steam phase. The RWGS reaction is endothermic and therefore proper heat management is required to achieve efficient production of syngas 102 by chemical system 100.

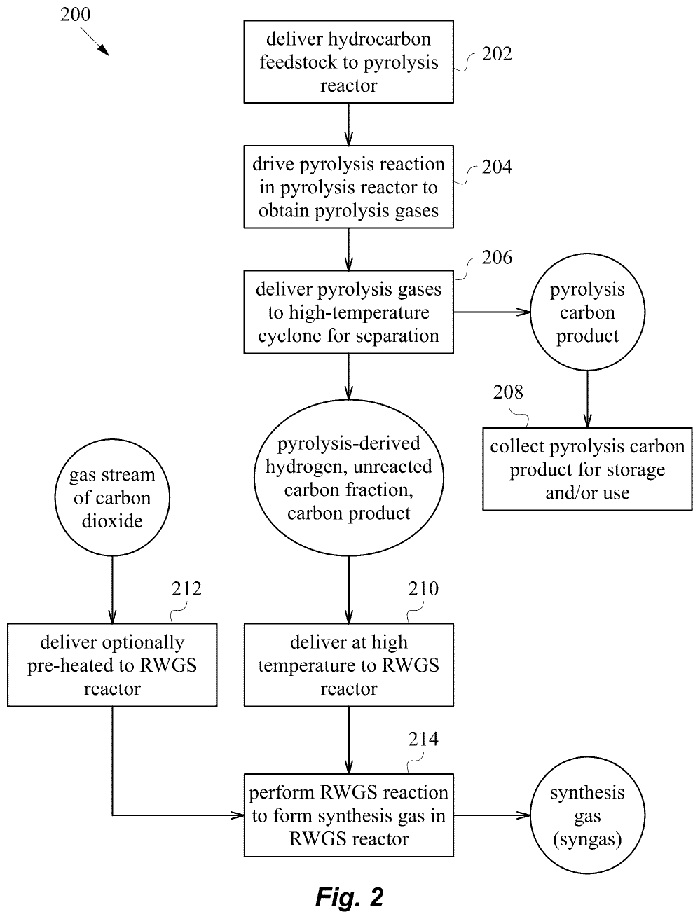

The operation of chemical system 100, including proper management of RWGS reaction in RWGS reactor 148 will now be explained with reference to a flow diagram 200 shown in FIG. 2 and with reference to elements illustrated in FIG. 1.

In a first step 202 hydrocarbon feedstock 106, in the form of natural gas in the present embodiment, is delivered or provided to pyrolysis reactor 104. Natural gas 106 is a low-cost resource and it is obtained from any suitable existing natural gas infrastructure.

In a subsequent step 204, pyrolysis of natural gas 106 is driven in pyrolysis reactor 104 in an oxygen-free environment. The energy for driving the pyrolysis reaction is provided by power supply 122. Preferably, power supply 122 uses grid electricity or renewable electricity for driving the pyrolysis reaction. Renewable electricity from hydro-electric, nuclear, or wind and solar with energy storage is an advantageous choice for power supply 122. It is important to perform pyrolyzation step 204 at a pyrolyzation temperature between 500° C. and 1,600° C. Pyrolysis gases 120 thus obtained essentially include pyrolysis carbon product 116, hydrocarbon fraction 118 and pyrolysis-derived hydrogen 112. Note that pyrolysis carbon product 116 mostly composed of solid carbon 136 is carried out of pyrolysis reactor 104 by pyrolysis gasses which have a sufficient velocity to fluidize out the carbon. Further, it is preferable to operate pyrolysis reactor 104 to obtain a reaction yield of hydrocarbon feedstock 106 to pyrolysis-derived hydrogen 112 greater than 70%.

In a following step 206, pyrolysis gases 122 produced by performing pyrolysis in step 204 are delivered to high-temperature cyclone 124. During step 206 pyrolysis gases 120 are separated such that pyrolysis carbon product 116, here mostly in the form of solid carbon 136 is discharged from bottom outlet 132 of high-temperature cyclone 124. Preferably, over 60% to over 90% of pyrolysis carbon product 116 by mass is separated during step 206. It is important that step 206 be performed while maintaining pyrolysis gases 120 at a temperature of over 800° C., which is below the pyrolyzation temperature, but is still high. This is done to maintain low CO₂ emissions, as excess solid carbon 136 could turn into CO₂. Maintaining high temperature also improves the energy efficiency of the process by eliminating the need to reheat pyrolysis-derived hydrogen 112.

In a step 208 pyrolysis carbon product 116 separated in high-temperature cyclone 124 during step 206 is sent to collection vessel 134. In this step precautions are taken to ensure that at most 5% of pyrolysis-derived hydrogen 112 is lost. Again, pyrolysis carbon product 116 is in the form of solid carbon 136 and it can thus be collected and stored for various applications in vessel 134. Over 50% and preferably over 90% of pyrolysis carbon product 116 produced by pyrolysis reactor 104 is removed in step 208 while maintaining pyrolysis gasses 120 at a temperature above 900° C. using high-temperature cyclone 124. In other words, over 90% of the fossil-derived carbon is removed in step 208 from chemical system 100. Note, the separation of solid carbon 136 is critical to minimize the formation of carbon monoxide and carbon dioxide in chemical system 100. Furthermore, for emission control, especially for PM2.5 or PM1 (particles smaller than 2.5 microns and 1 micron, respectively), high-temperature cyclone 124 can be followed by a secondary separator like a fabric filter or electrostatic precipitator (not shown). Nonetheless, highly efficient cyclones have been designed for lower flow rates, as exemplified by Dyson's successful bagless vacuum cleaners (U.S. Pat. No. 4,593,429, 1986). Small cyclones are also utilized for stack sampling and particle-size analysis.

Meanwhile, in a step 210 pyrolysis gases 120 exiting through central outlet pipe 138 are sent in the form of flow 140 to RWGS reactor 148. Note that flow 140 contains pyrolysis-derived hydrogen 112 and unreacted carbon fraction 118 separated in high-temperature cyclone 124 as well as a small amount of pyrolysis carbon product 116 that was not separated in high-temperature cyclone 124. It is important that flow 140 of pyrolysis gases 120 be maintained at a temperature above 800° C. Maintaining such high temperature is important for proper heat integration to ensure that no additional heating of flow 140 is required prior to entering RWGS reactor 148.

In a parallel step 212, gas stream 144 of carbon dioxide gas 146, optionally pre-heated, is delivered to RWGS reactor 148. In embodiments with pre-heating the carbon dioxide gas is pre-heated to a temperature above 300° C. to above 500° C. prior to being received in RWGS reactor 148.

In a step 214 synthesis gas or syngas 102 is formed during the reaction between carbon dioxide gas 146 and principally pyrolysis-derived hydrogen 112 present in pyrolysis gases 120. The RWGS reaction taking place within tubes 150 of RWGS reactor 148 relies on the hot pyrolysis- derived hydrogen 112 transferring energy to carbon dioxide gas 146 and bringing the temperature of the pyrolysis-derived hydrogen 112 and carbon dioxide gas 146 (H₂/CO₂ mixture) to a shift temperature above 800° C. and preferably between 900° C. and 1,300° C. At such high shift temperature the RWGS reaction shown in Eq. 1 below is favorable and the formation of CH₄ or solid coke is unfavorable.

$${CO}_{2} + {H}_{2} ⇌ CO + {H}_{2} O \qquad ( Eq . 1 )$$

As noted, the RWGS reaction is endothermic, and thus proper heat management is necessary to ensure that the shift temperature does not drop too much within tubes 150 prior to achieving a sufficient yield of carbon dioxide to carbon monoxide in RWGS reactor 148. In embodiments where shift temperature in RWGS reactor 148 is kept above 1,000° C., and especially above 1,200° C., it is not necessary to employ a catalyst to increase the reaction rate of the RWGS reaction. That is because the reaction will proceed at a sufficient rate without any catalyst.

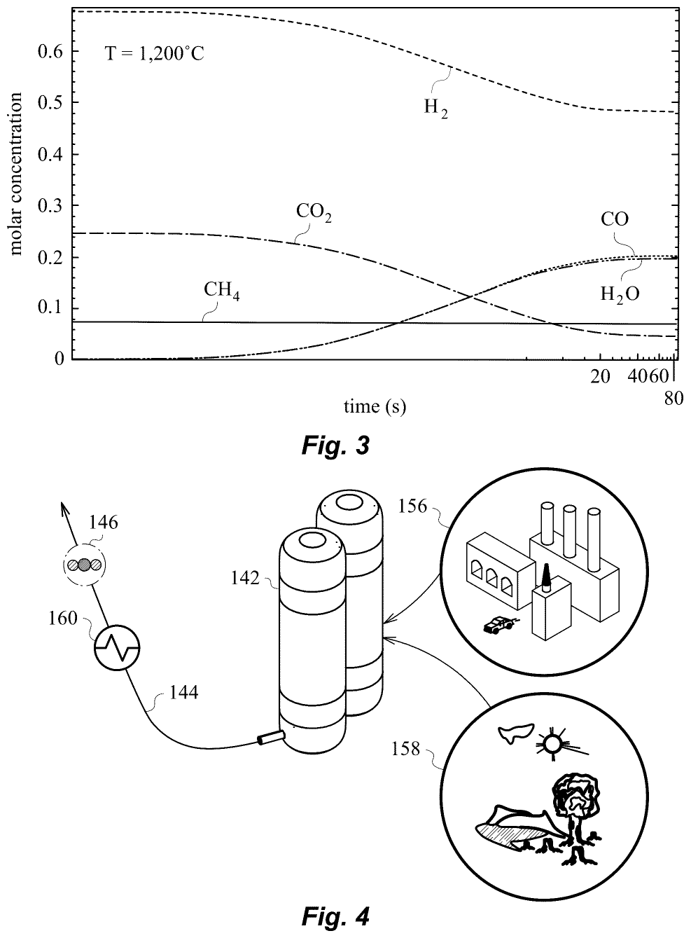

The progress of RWGS reaction at a shift temperature of 1, 200° C. without catalyst is shown by the plots of FIG. 3 that illustrate changes in molar concentrations of gases within tubes 150 in time. A person skilled in the art will be able to adjust the length of tubes 150 given the flow rates to ensure sufficient time for the RWGS reaction to take place. Molar concentration of pyrolysis-derived hydrogen 112 labeled as He in the plot of FIG. 3 drops as molar concentrations of carbon monoxide (CO) and water (H₂O) rise. Note that the plot of the concentration of CO is directly on top of that for the concentration of H₂O since they are produced in a 1:1 ratio as H₂ is consumed. Meanwhile, the concentration of unreacted hydrocarbon fraction 118 in pyrolysis gases 120 and labeled here as CH₄ (most abundant component) stays unchanged. Referring back to FIG. 1, we see that syngas 102 obtained in this manner contains its primary components 102′, namely hydrogen (H₂) and carbon monoxide (CO). Further, syngas 102 has an additional mixture of carbon dioxide (CO₂) and water (H₂O).

In embodiments where shift temperature in RWGS reactor 148 is lower, e.g., just above 800° C. but still below 1,000° C. or at about the temperature of pyrolysis gases 120 entering RWGS reactor 148 a catalyst In the embodiment shown in FIG. 1 the catalyst is a is required. nickel-based catalyst 154, as used in steam methane reforming. Pyrolysis gases 120 containing pyrolysis-derived hydrogen 112 and carbon dioxide gas 146 flow over nickel-based catalyst 154 that is either deposited on the inside of stainless steel tubes 150 or fills tubes 150 as particles and the RWGS reaction progresses. Nickel-based catalyst 154 catalyzes the RWGS reaction to form syngas 102 with a 2:1 ratio of H₂ to CO, suitable for methanol production. In an alternative embodiment, tubes 150 themselves are made of a nickel superalloy that catalyzes the RWGS reaction. Nickel superalloys are a group of materials that have high strength, durability, and resistance to high temperatures, making them suitable for use in extreme environments such as gas turbines, jet engines, and nuclear reactors. Some of the most common nickel superalloys include: inconel, hastelloy, waspaloy, incoloy, and rene alloys.

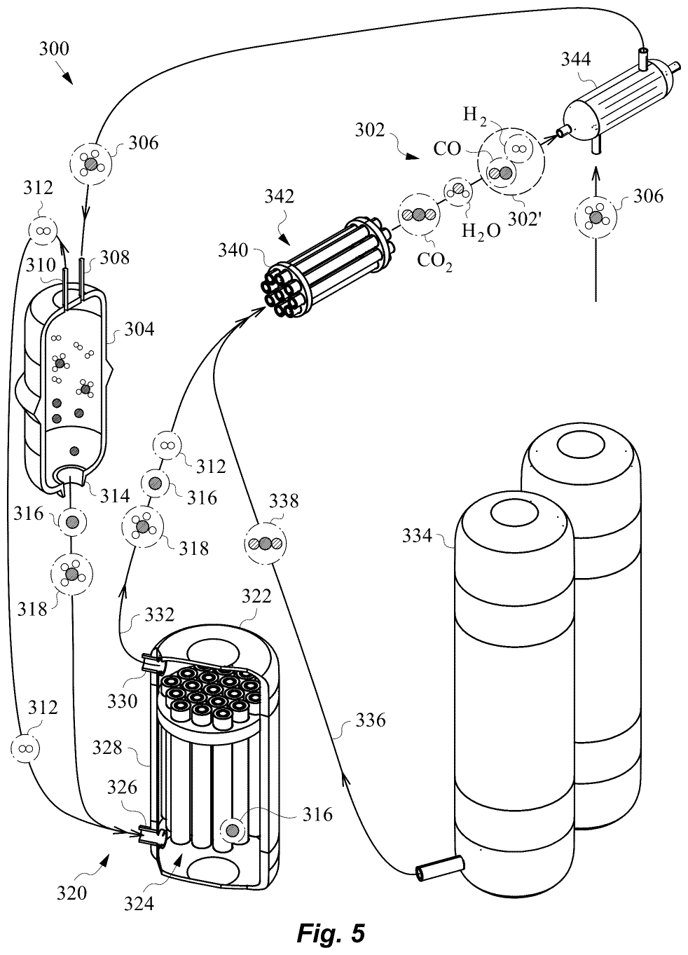

FIG. 4 illustrates preferred sources of carbon dioxide for gas stream 144. Specifically, carbon dioxide from waste generated by human activities 156 and biogenic carbon dioxide 158 are preferred. Waste carbon dioxide 156 is generated primarily through the burning of fossil fuels such as coal, oil and natural gas. This includes emissions from power plants, industrial processes, transportation as well as residential and commercial buildings. Waste CO₂ can also be generated from the combustion of biomass such as wood and from waste-to-energy processes that convert organic materials into energy. Biogenic carbon dioxide 158 is primarily generated by natural biological processes, such as respiration and decomposition of organic matter. This includes CO₂ emitted by plants, animals, and microorganisms as part of their natural life cycles. For example, during photosynthesis, plants absorb CO₂ from the atmosphere and convert it into organic matter through a process that releases oxygen. Later, when plants and animals die or decompose, the organic matter is broken down, and CO₂ is released back into the atmosphere through respiration or decay. Biogenic CO₂ can also be generated by natural sources such as volcanic activity and wildfires. Volcanic activity releases CO₂ that has been stored in the earth's crust, while wildfires release CO₂ stored in the organic matter of vegetation. In addition, human activities such as deforestation and land use changes can lead to the release of biogenic CO₂ by reducing the amount of carbon stored in forests and soils. One example of a biogenic source of CO₂ which can be used in this process is CO₂ from corn-based ethanol production. Note that United States corn-based ethanol production results in about 37 million metric tons (MMT) of CO₂ emissions at high purity, enough to produce 27 MMT of methanol—triple the existing US methanol production capacity.

FIG. 4 also shows a heater 160 designed to pre-heat gas stream 144. As mentioned, preferably carbon dioxide gas 146 from waste and/or biogenic sources 156, 158 is preheated to a temperature above 300° C. or even to above 500° C. Delivering carbon dioxide gas 146 at such high temperature aids in the thermal management of the RWGS reaction in RWGS reactor 148 (see FIG. 1).

Chemical system 100 and associated method of the invention offers significant advantages over the state-of-the-art in terms of carbon intensity reduction and energy savings. First, it drops out the fossil-derived carbon as solid carbon 136 that can be stored or sequestered and instead utilizes waste and/or biogenic carbon dioxide sources 156, 158. Second, it leverages thermal integration to minimize the energy input required to run the RWGS reaction. Third, it avoids carbon dioxide emissions from the combustion of fossil fuels by electrifying the process.

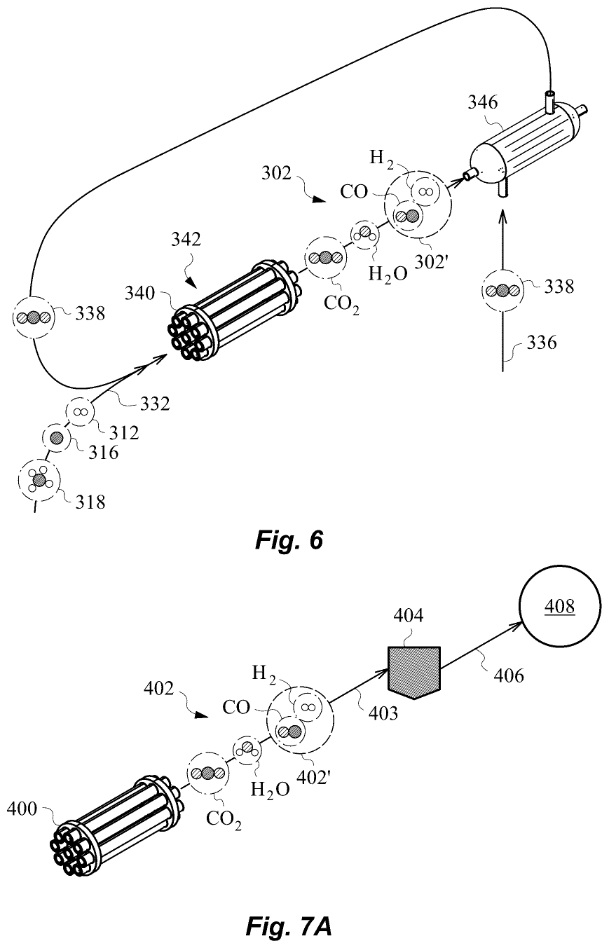

FIG. 5 illustrates another chemical system 300 according to the invention for producing syngas 302 whose primary components 302′ are hydrogen (H₂) and carbon monoxide (CO). Syngas 302 also contains an additional mixture of carbon dioxide (CO₂) and water (H₂O). Chemical system 300 has a pyrolysis reactor 304 for pyrolyzing a hydrocarbon feedstock 306 such as primarily or essentially methane or natural gas. In the present embodiment hydrocarbon feedstock is natural gas 306 indicated in highly magnified form within a dashed and dotted outline by its most abundant component, methane (CH₄).

Pyrolysis reactor 304 is powered by an electrical power supply (not shown) for heating pyrolysis reactor 304 to a pyrolyzation temperature between 500° C. and 1,600° C. Further, pyrolysis reactor 304 has an inlet 308 for admitting natural gas 306 and a top outlet 310 for releasing pyrolysis-derived hydrogen 312. At the bottom, pyrolysis reactor 304 has a bottom outlet 314 for releasing a pyrolysis carbon product 316. Pyrolysis carbon product 316 in the present embodiment is solid carbon visualized in highly magnified molecular form within a dashed and dotted outline.

As in the previous embodiment, it is important that pyrolysis carbon product 316 be fluidized out of pyrolysis reactor 304 along with pyrolysis-derived hydrogen 312 and a hydrocarbon fraction 318. Hydrocarbon fraction 318 at bottom outlet 314 is principally composed of unreacted natural gas 306. Hence, it is also visualized in highly magnified molecular form within dashed and dotted outline by its most abundant component, methane (CH₄). More generally, however, hydrocarbon fraction 318 will consist of a variety of hydrocarbons such as methane, ethane, ethylene, acetylene, and aromatic hydrocarbons.

Together, pyrolysis-derived hydrogen 312, pyrolysis carbon product 316 and hydrocarbon fraction 318 constitute pyrolysis gases 320. In the present invention the most important components of pyrolysis gases 320 are pyrolysis-derived hydrogen 312 and pyrolysis carbon product 316. Thus, when pyrolysis gases 320 are referred to herein it will be understood that they contain at least these most important components.

Chemical system 300 has a high-temperature carbon separation mechanism 322 positioned for receiving pyrolysis gases 320 from pyrolysis reactor 304. High-temperature carbon separation mechanism 322 in the present embodiment is a high-temperature candle filter 322. The function of high-temperature candle filter 322 is to separate pyrolysis carbon product 316 from pyrolysis gases 320 while maintaining their temperature above 800° C. Preferably, high-temperature candle filter 322 separates pyrolysis carbon product 316 from pyrolysis gases 320 at a separation efficiency of over 60% by mass, and more preferably still at a separation efficiency of over 90% by mass.

High-temperature candle filter 322 is a type of filtration device that uses cylindrical filter elements 324, commonly referred to as candles. Candles 324 are designed to operate at high temperatures to remove impurities and particles from a fluid or gas stream that enters through a bottom filter inlet 326. In the present case cylindrical filter elements or candles 324 are sintered candle filters. Candles 324 consist of a porous media, such as ceramic, metal, or polymer, that allows the fluid or gas to flow through while capturing solid particles. Candles 324 are arranged vertically within a filter housing 328.

Pyrolysis gases 320 to be filtered enter through bottom filter inlet 326 and pass through candles 324 from the outside to the inside. This allows pyrolysis carbon product 316 to be trapped on the outer surfaces of candles 324. Meanwhile, pyrolysis-derived hydrogen 312 contained in pyrolysis gases 320 flows through candles 324, passes to their inside and exits through a top filter outlet 330.

The trapped particles of pyrolysis carbon product 316 build up on the surface of candles 324, forming a filter cake. The filter cake is periodically removed through cleaning or replacement of candles 324. Pyrolysis carbon product 316 is thus removed during the cleaning or replacement of candles 324. Candle filters are commonly used in various industrial applications, including wastewater treatment, chemical processing, and pharmaceutical manufacturing, due to their high efficiency, low maintenance, and cost-effectiveness.

The maximum operating temperature of high-temperature candle filter 322 depends on the material of candles 324 and the type of fluid or gas being filtered. In the present case, ceramic candle filters 324 can typically operate at temperatures up to and between 900° C. to 1,000° C. A ceramic like silicon carbide is preferably used as the material in order to enable operation at temperatures above 900° C. However, the maximum temperature can be limited by the design of filter housing 328 and the seals used, which may not be able to withstand extreme temperatures. Care should be taken that pyrolysis gases 320 do not contain admixtures of fluids or gasses that may contain components that corrode or erode elements of candle filters 324, reducing their effectiveness or causing them to fail prematurely.

Candle filters in general have several limitations that may make their usage challenging under some conditions. First, the filter cake that forms on the surface of candles 324 can cause a pressure drop and reduce flow rates from filter inlet 326 through filter 322 to filter outlet 330. This may require frequent cleaning or replacement of candles 324. Second, the filter cake can also reduce the efficiency of filter 322, particularly for particles of pyrolysis carbon product 316 and any other particulates that are smaller than the pore size of candles 324. Third, candle filters may not be suitable for fluids or gasses that contain high concentrations of solids, as this can quickly clog candles 324. Finally, the cost of candle filters can be higher compared to other types of filtration devices, particularly for applications that require high-temperature or corrosion-resistant materials. Therefore, care should be taken in performing pyrolysis in pyrolysis reactor 304 to limit particulate content in pyrolysis gases 320.

In some embodiments that mitigate these known limitations, candle filter 322 is used in combination with a high-temperature cyclone of the type described above. The high-temperature cyclone is positioned to receive pyrolysis gases 320 first. It removes the larger particles from pyrolysis gasses 320 and decreases the concentration of solids so that candle filter 322 positioned downstream from the cyclone can operate more effectively.

A flow 332 of pyrolysis gases 320 largely consisting of pyrolysis-derived hydrogen 312 and small amounts of unreacted hydrocarbon fraction 318 as well as some unseparated pyrolysis carbon product 316 exits candle filter 322 through filter outlet 330. Flow 332 is maintained at a high temperature. The specific temperature depends on the application as discussed in more detail below.

Chemical system 300 has a carbon dioxide source 334 for providing a gas stream 336 primarily made up of a carbon dioxide gas 338. The latter is visualized in highly magnified molecular form within a dashed and dotted outline.

A RWGS reactor 340 of chemical system 300 is configured to receive both flow 332 of pyrolysis gases 320 from high-temperature candle filter 322 and gas stream 336 of carbon dioxide gas 338 from carbon dioxide source 334. RWGS reactor 340 has a number of tubes 342 for admitting flow 332 of pyrolysis gases 320 and gas stream 336 of carbon dioxide gas 338. The RWGS reaction between pyrolysis-derived hydrogen 312 and carbon dioxide gas 338 takes place inside tubes 342 and is either catalyzed or uncatalyzed depending on shift temperature as explained above. The reaction forms syngas 102 that is released from tubes 342 of RWGS reactor 340. Syngas 302 is made up primarily of hydrogen H-and carbon monoxide CO jointly denoted as 302′, but it also has an additional mixture of carbon dioxide CO₂ and water H₂O in steam phase.

Chemical system 300 has a heat exchanger 344 positioned downstream from RWGS reactor 340 for receiving syngas 302. Syngas 302 is deployed by heat exchanger 344 as the heating medium or working fluid in this configuration. Specifically, syngas 302 exiting RWGS reactor 340 at high shift temperature above 800° C. and up to 1,200° C. carries a large amount of heat energy. This heat energy is advantageously used for transferring heat or pre-heating hydrocarbon feedstock 306 on its way from its source (not shown) to pyrolysis reactor 304. The pre-heating of hydrocarbon feedstock 306 prior to pyrolysis in pyrolysis reactor 304 represents an important piece of thermal integration in chemical system 300 to minimize electricity consumption.

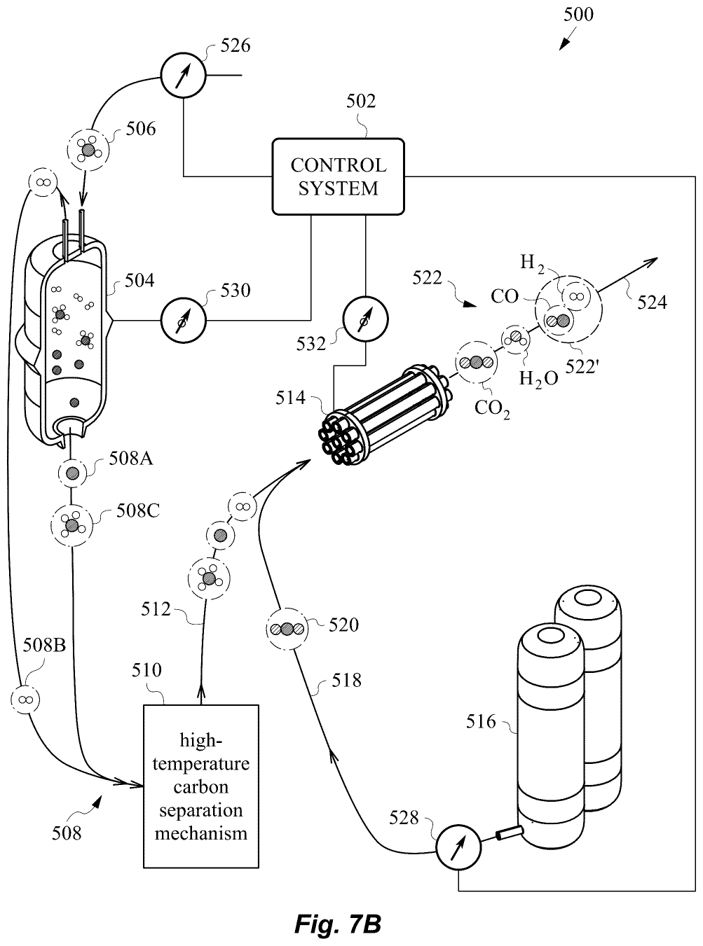

FIG. 6 illustrates an alternative embodiment of a portion of chemical system 300 that uses another heat exchanger 346. Heat exchanger 346 is also positioned downstream from RWGS reactor 340 and deploys syngas 302 as the heating medium of working fluid. This time, however, the heat energy of syngas 302 is used for transferring heat or pre-heating gas stream 336 of carbon dioxide gas 338. Thus, carbon dioxide gas 338 is brought to a suitable temperature, e.g., above 300° C. or even above 500° C. prior to entering RWGS reactor 340 along with flow 332 of pyrolysis gases 320 arriving from candle filter 322 (see FIG. 5). Of course, a person skilled in the art will realize that given the high heat energy in syngas 302 heat exchangers 344 and 346 can be used simultaneously to pre-heat both pyrolysis feedstock 306 and carbon dioxide gas 338.

The operation of chemical system 300 is analogous to the operation of chemical reactor 100 and proceeds in the manner described in the flow diagram of FIG. 2 with the addition of heat-exchange steps and replacement of the high-temperature cyclone with high-temperature candle filter 322 (or high-temperature cyclone and high-temperature candle filter) in step 206.

The chemical systems and methods for producing syngas according to the invention admit of various additional elements and steps. These aim to take advantage of the available thermal energy as well as to perform various functions to tune the chemical system and/or to better prepare the syngas produced for downstream applications.

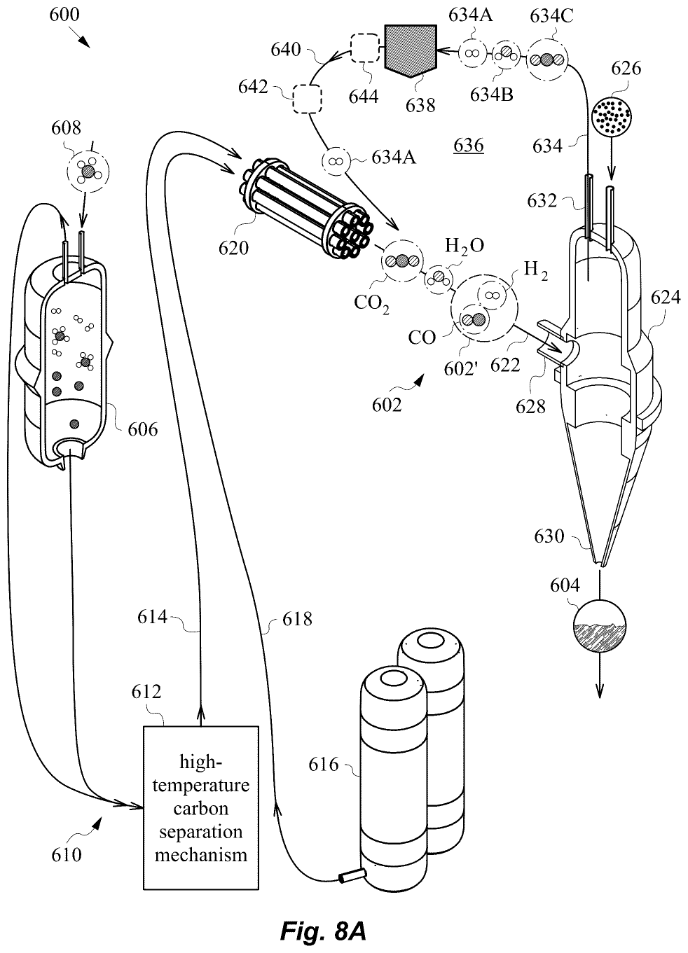

FIG. 7A illustrates an embodiment of a RWGS reactor 400 that can be deployed in any of the previously described chemical systems. RWGS reactor 400 produces syngas 402 primarily composed of CO and H₂ and designated 402′. Syngas 402 contains an additional mixture of CO₂ and H₂O.

A wet scrubber 404 is positioned downstream from RWGS reactor 400 to receive syngas 402. Wet scrubber 404 removes contaminants from syngas 402. Specifically, when syngas 402 is intended for chemical production it is desirable for wet scrubber 404 to minimize the amount of particulates in syngas 402 and issue a cleaned syngas stream 406. Thus, wet scrubber 404 is of the type that is commonly used to remove particulate matter from a gas stream and in this case syngas stream 403. It works by introducing a liquid into syngas stream 403, which captures the particles and removes them. The process begins by forcing syngas stream 403 through a chamber that contains a liquid spray. As syngas stream 403 moves through the spray, the liquid droplets collide with the particles in syngas stream 403. The particles stick to the liquid and are carried away. The liquid and the captured particles are then collected in a reservoir at the bottom of wet scrubber 404. The liquid used in wet scrubber 404 is often water, but it can also be a chemical solution that is specifically designed to react with and capture certain types of particulate matter. The liquid is typically circulated through wet scrubber 404 to ensure that it is continually capturing particles and removing them from syngas stream 403.

Once the liquid in wet scrubber 404 has become saturated with captured particles, it needs to be treated or disposed of appropriately to prevent any environmental contamination. The remaining syngas stream 403 is then typically passed through a series of additional filters or scrubbers (not shown) to remove any remaining contaminants before it is released back into the environment as cleaned syngas stream 406.

Wet scrubbers are widely used in a variety of industrial applications, including power generation, chemical processing, and manufacturing, where they help to reduce air pollution and protect the health and safety of workers and the public.

The RWGS reaction produces water vapor during the production of carbon monoxide from carbon dioxide and hydrogen. Thus, in addition to particulate removal it is sometimes beneficial to further purify syngas stream 406 from carbon dioxide and any remaining water in syngas stream 406. Thus, syngas stream 406 can be further processed through a water and/or carbon dioxide removal system 408 for removing at least a portion of the mixture of carbon dioxide and water from syngas stream 406. Suitable removal systems include flash separation systems, pressure swing adsorber systems, thermal swing adsorber systems, or other dehydration and CO removal systems. Of course, it is possible to just use the removal system 408 without the interposed wet scrubber if syngas stream 403 is already reasonably free of particulates.

In embodiments where removal system 408 is a flash separation system its operation is based on the principle of phase separation. Specifically, when syngas stream 406 containing water vapor is cooled, the water vapor will condense into liquid droplets. By cooling syngas stream 406 to a temperature below the dew point of the water vapor, the water droplets can be separated from the gas. In a flash separation system, the gas stream is typically passed through a series of heat exchangers and coolers to reduce the temperature of syngas stream 406. Syngas stream 406 is then fed into a separator vessel, where it is allowed to expand rapidly, causing a drop in pressure. This sudden drop in pressure causes the water droplets to vaporize, separating them from syngas stream 406. The water vapor and gas mixture are then passed through a mist eliminator to remove any remaining water droplets. The dry syngas stream 406 is then passed through a final cooler to bring it to the desired temperature before being released. The separated water is typically collected in a liquid trap or separator vessel and then removed from the system. The water can either be disposed of or for reuse, depending on the specific application and treated regulations.

In some embodiments, removal system 408 is a pressure swing adsorber (PSA) system used to remove impurities, such as water and CO., from syngas stream 406. This process is commonly used in the production of high-purity gases for industrial and medical applications. The PSA process works by using adsorbent materials, such as zeolites or activated carbon, to selectively remove the impurities from syngas stream 406. The adsorbent material is typically packed into a vessel or bed, which is then pressurized with syngas stream 406 to be treated. When syngas stream 406 is passed through the bed, the impurities are adsorbed onto the surface of the adsorbent material, leaving the purified gas to pass through and exit the vessel. The amount of impurities that can be removed depends on the specific adsorbent material used, as well as the operating conditions of the PSA system. Once the adsorbent bed is saturated with impurities, the pressure in the vessel is released, allowing the adsorbent material to desorb the impurities back into syngas stream 406. This process is known as regeneration and typically involves lowering the pressure in the vessel, which causes the adsorbent material to release the impurities. The desorbed gas stream is then vented or sent to a separate purification unit to remove the impurities. After regeneration, the adsorbent bed is ready to be used again for the next adsorption cycle. The PSA process is often used in combination with other gas purification technologies to achieve high-purity gas streams. For example, a PSA system can be used to remove water and CO₂ from syngas stream 406 before it is passed through a membrane or catalytic converter to remove other impurities.

In some embodiments, removal system 408 is a thermal swing adsorber (TSA) which is another technology used to remove impurities such as water and CO₂ from a syngas stream 406. The TSA process works by using adsorbent materials, such as zeolites or silica gel, to selectively adsorb the impurities from syngas stream 406 at high temperature. The adsorbent material is typically packed into a vessel or bed, which is then heated to a high temperature. When syngas stream 406 is passed through the bed, the impurities are adsorbed onto the surface of the adsorbent material, leaving the purified syngas stream 406 to pass through and exit the vessel. The amount of impurities that can be removed depends on the specific adsorbent material used, as well as the operating conditions of the TSA system. Once the adsorbent bed is saturated with impurities, the bed is cooled down to a low temperature. This causes the adsorbent material to release the impurities back into syngas stream 406. This process is known as regeneration. The desorbed syngas stream 406 is then vented or sent to a separate purification unit to remove the impurities. After regeneration, the adsorbent bed is ready to be used again for the next adsorption cycle. The TSA process is often used in combination with other gas purification technologies to achieve high-purity gas streams. For example, a TSA system can be used to remove water and CO. from syngas stream 406 before it is passed through a membrane or catalytic converter to remove other impurities.

FIG. 7B illustrates an embodiment of a chemical system 500 with a control system 502. Only the controlled portions of chemical system 500 are shown for clarity. The remaining elements of chemical system 500 can be analogous to those described in the previous embodiments.

Chemical system 500 has a pyrolysis reactor 504 for pyrolyzing a hydrocarbon feedstock 506 in the manner described above to produce pyrolysis gases 508. The components of pyrolysis gases 508 include pyrolysis carbon product 508A, pyrolysis-derived hydrogen 508B and hydrocarbon fraction 508B. Pyrolysis gases 508 are delivered to a high-temperature carbon separation mechanism 510 that can have one or more high-temperature cyclones and/or high-temperature candle filters. High-temperature carbon separation mechanism 510 removes pyrolysis carbon product 508B from pyrolysis gases 508 and passes a flow 512 of pyrolysis gases 508 with most of pyrolysis carbon product 508B removed to a RWGS reactor 514.

Further, chemical system 500 has a carbon dioxide source 516 for delivering a gas stream 518 of carbon dioxide gas 520. Gas stream 518 is also delivered to RWGS reactor 514. RWGS reactor 514 produces syngas 522 primarily composed of CO and H₂ and designated 522′. Syngas 522 contains an additional mixture of CO₂ and H₂O. The output of RWGS reactor 514 is obtained in the form of a syngas stream 524.

Control system 502 has a first control unit 526 for varying the amount of hydrocarbon feedstock 506 being delivered to pyrolysis reactor 504. Also, control system 502 has a second control unit 528 for varying the amount of carbon dioxide gas 520 in gas stream 518. Standard valve and pump mechanisms can be deployed as first and second control units 526, 528.

Control system 502 also has a first regulation unit 530 for varying the pyrolyzation temperature in pyrolysis reactor 504 and a second regulation unit 532 for varying the shift temperature in RWGS reactor 514. First and second regulation units 530, 532 can deploy standard supply energy regulation devices.

During operation control system 502 uses its control units 526, 528 to vary the amounts of hydrocarbon feedstock 506 and of carbon dioxide gas 520. In addition, control system 502 uses its regulation units 530, 532 to vary the pyrolyzation temperature and the shift temperature. As a result, control system 502 affords control over the relative composition of hydrogen, carbon monoxide, carbon dioxide and water in syngas 522. Preferably, control system 502 is tuned such that syngas 522 contains over 40% hydrogen by volume and over 15% carbon monoxide by volume.

Furthermore, control system 502 is preferably also tuned such that pyrolysis reactor 504 allows for pyrolysis carbon product 508A to be fluidized out of pyrolysis reactor 504 by pyrolysis gases 508. This facilitates the transfer of pyrolysis carbon product 508A to high-temperature carbon separation mechanism 510 and helps in the separation process. In addition, it is preferable to operate pyrolysis reactor 504 to obtain a reaction yield of hydrocarbon feedstock 506 to pyrolysis-derived hydrogen 508B greater than 70%.

Control system 502 can further used to more effectively control the shift temperature in RWGS reactor 514. This may happen when flow 512 of pyrolysis gases 508 arriving from high-temperature carbon separation mechanism 510 are at very high temperatures, e.g., because of upper range pyrolyzation temperatures near 1,600° C. used in pyrolysis reactor 504. In those situations, control system 502 uses gas stream 518 of carbon dioxide gas 520 controlled with control unit 528 to cool pyrolysis gases 508 either before entry or within RWGS reactor 514. More specifically, since shift temperature should be below 1,200° C., control system 502 is used to ensure that pyrolysis gases 508 in flow 512 fall below 1,200° C. either shortly before or upon entering RWGS reactor 514. Because gas stream 518 is used as a coolant in this case, no pre-heating is applied to it. It should be noted that one of the most important parameters that control system 502 can affect is the flow rate of gas stream 518.

Generally, synthesis gas formed according to the invention in RWGS reactor using pyrolysis-derived hydrogen from the pyrolysis reactor and the integrated thermal management of the invention can be used in many types of downstream systems and applications, or it can be stored. There are several advantageous embodiments of the invention depending on the use of synthesis gas as well as overall conditions under which the synthesis gas is obtained.

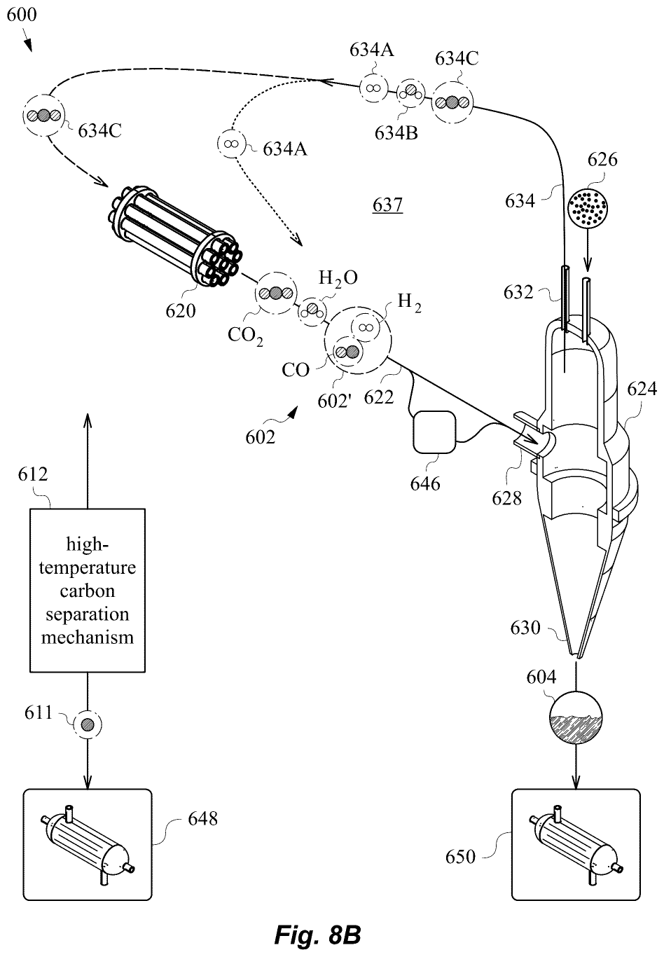

FIG. 8A is a schematic diagram of an advantageous system 600 that combines producing syngas 602 and also obtaining a metal oxide reduction product 604 that is produced in a metal oxide reduction reaction with synthesis gas 602. System 600 has many analogous elements that share the same operation principles with the previously described embodiments. Therefore, only aspects of system 600 that pertain to its use in conjunction with obtaining metal oxide reduction product 604 will be addressed in detail.

System 600 has a pyrolysis reactor 606 for pyrolyzing a hydrocarbon feedstock 608 into pyrolysis gases 610 at a pyrolyzation temperature between 500° C. and 1,600° C. A high-temperature carbon separation mechanism 612 embodied by a high-temperature cyclone and/or a high-temperature candle filter is configured to receive pyrolysis gases 610 from pyrolysis reactor 606 and separate out a pyrolysis carbon product (not shown). Preferably, high-temperature carbon separation mechanism 612 separates out the pyrolysis carbon product at over 60% to over 90% by mass.

The temperature of pyrolysis gases 610 in high-temperature carbon separation mechanism 612 is maintained above 800° C. Hence, a flow 614 of pyrolysis gases 610 leaving high-temperature carbon separation mechanism 612 with most of pyrolysis carbon product removed contains a large amount of thermal energy for use in producing syngas 602 according to the invention.

System 600 has a carbon dioxide source 616 that provides a gas stream 618 of primarily carbon dioxide gas. Preferably the carbon dioxide gas is obtained from biogenic or waste sources.

System 600 also has a RWGS reactor 620 for receiving pyrolysis gases 614 from high-temperature carbon separation mechanism 612. RWGS reactor 620 also receives gas stream 618 from carbon dioxide source 616. The RWGS reaction taking place in RWGS reactor 620 at a shift temperature above 800° C. and up to 1,200° C. produces syngas 602. The main components of syngas 602, namely hydrogen (H₂) and carbon monoxide (CO) are designated 602′. Syngas 602 also contains an additional mixture of CO₂ and H₂O. Syngas 602 formed in RWGS reactor 620 is delivered in the form of a syngas stream 622 for downstream use.

Downstream from RWGS reactor 620 system 600 has a reduction furnace 624 for running the metal oxide reduction reaction. In the present example reduction furnace 624 is a Direct Reduced Iron (DRI) furnace designed for reducing a metal oxide 626 embodied in this example by iron ore. Iron ore 626 is typically delivered in the form of iron pellets, as visualized in FIG. 8A.

Since metal oxide 626 is iron ore, metal oxide reduction product 604 is reduced iron (Fe) in this example. It should be noted, however, that the metal oxide reduction reaction can be practiced with other metal oxides besides iron ore 626. Specifically, besides iron ore 626 metal oxide reduction reaction can be practiced with metal oxides selected from among tin oxide, lead oxide, nickel oxide, copper oxide and cobalt oxide. In those cases, metal oxide reduction product will be the corresponding reduced metal.

As iron ore 626 is admitted into Direct Reduced Iron (DRI) furnace 624 to undergo the reduction reaction syngas stream 622 is also admitted at a high temperature, i.e., near the shift temperature of RWGS reaction, into DRI furnace 624 through furnace inlet 628. Thus, in the present example, metal oxide reduction product 604 is reduced iron (Fe) or metallic iron using syngas stream 622 as the agent driving the reaction.

Reduced iron 604 is shown leaving DRI furnace 624 through a bottom furnace outlet 630. According to the invention it is preferable that syngas 602 contain a sufficient fraction of carbon in the form of carbon monoxide. This carbon fraction in syngas 602 supports the creation of a desirable fraction of carbon within metallic iron 604, which typically contains 1% to 4% carbon, produced inside DRI furnace 624.

DRI furnace 624 has a top furnace outlet 632 to allow a top gas 634 to leave. Top gas 634 exiting DRI furnace 624 still contains unreacted hydrogen 634A and some water 634B and carbon dioxide 634C. These components of top gas 634 are also visualized in highly magnified molecular form within dashed and dotted outlines.

It is advantageous to recycle unreacted hydrogen 634A as well as carbon dioxide 634C. System 600 thus has a recycle loop 636 for using top gas 634 from DRI furnace 624. More specifically, recycle loop 636 is configured for receiving top gas 634 from DRI furnace 624, drying it and reinjecting it for further use in system 600.

In the embodiment of FIG. 8A recycle loop 636 has a condenser 638 that removes water 634B to dry top gas 634. In addition, condenser 638 purifies top gas 634 to remove dust. The primary component of purified top gas 640 remaining after condensation and filtration in condenser 638 is unreacted hydrogen 634A and carbon dioxide 634C. Purified top gas 640 can thus be reinjected into syngas 602 flowing in syngas stream 622, as shown to complete recycle loop 636. Thus, purified top gas 640 is reintroduced into DRI furnace 624 mixed with syngas stream 622. In mixing and heat exchanging with syngas 602 in stream 622 low temperature unreacted hydrogen 634A from top gas 634 achieves the desired cooling of syngas 602 prior to entry into DRI furnace 624. The low temperature unreacted hydrogen 634A injected into stream 622 will also participate in the combustion in DRI furnace 624 to offset the endothermic reaction of metal oxide reduction that yields iron 604.

In still other embodiments, excess reducing gas in the form of purified unreacted hydrogen 634A can be re-heated. FIG. 8A shows an optional combustion unit 642 drawn in a dashed line. Combustion unit 642 is placed in recycle loop 636 for combusting purified top gas 640 to obtain high-temperature gases. Reinjecting thus heated purified top gas 640 adds heat to DRI reactor 624. Therefore, it serves in the reduction process yielding iron 602 to increase the rate of the reduction reaction without necessarily being used to cool syngas 602 in stream 622.

According to yet another alternative, purified unreacted hydrogen 634A and carbon dioxide 634C can be re-heated and injected into flow 614 of pyrolysis gasses 610 either before, during or after entering high-temperature carbon separation mechanism 612. Injection before or during the separation process in high-temperature carbon separation mechanism 612 permits it to operate at lower temperatures which is beneficial from a materials of construction and thermal loss perspective. However, in such embodiments carbon dioxide 634C in top gas 634 will react with any carbon present in pyrolysis gas stream 610. Therefore, injection after removal of pyrolysis carbon product in high-temperature separation mechanism 612 is preferred.

Purified unreacted hydrogen 634A from purified top gas 640 can be additionally processed and put to other uses. FIG. 8A shows an optional removal system 644 drawn in a dashed line next to condenser 638. Removal system 644 is designed for further removal of any residual particulate matter, carbon dioxide and non-reducing gasses and any other undesirable components. A thus duly purified portion or all of purified top gas 640 can be removed from system 600 and provided to a third party or it can be used in a fuel cell to generate renewable energy. The connections that such variants of systems 600 would require can be implemented by those skilled in the art based on well-known techniques.

FIG. 8B illustrates system 600 with several additional advantageous elements. Only the salient parts of system 600 are shown for reasons of clarity.

In FIG. 8B system 600 has a syngas combustion unit 646 for combusting a portion of syngas 602 in syngas stream 622 to create a high-temperature syngas prior to its entry into DRI furnace 624. For this reason, a portion of syngas stream 622 is diverted into syngas combustion unit 646. In this manner heat can be added to DRI furnace 624. Of course, entire syngas stream 622 without diversion can be combusted in syngas combustion unit 646 in some embodiments to add heat to DRI furnace 624. Combustion also acts to convert any residual carbon soot or hydrocarbons to carbon dioxide and water.

System 600 has an extended recycle loop 637 to act as a mechanism for recycling both unreacted hydrogen 634A as well as a stream of carbon dioxide 634C from top gas 634. The various systems for filtering, drying, combusting and performing any other operations on top gas 634 in extended recycle loop 637 are not shown as they are well known in the art. It is noted that in some embodiments extended recycle loop 637 can purify top gas 634 to remove particulate matter and/or carbon dioxide and/or non-reducing gases.

In the embodiment shown, extended recycle loop 637 reinjects hydrogen 634A into stream 622 of syngas 602 and reinjects carbon dioxide 634C into RWGS reactor 620. Thus, recycled carbon dioxide 634C forms carbon monoxide CO during the RWGS reaction and then forms carbon dioxide again in DRI furnace 624. Then, after it exits in top gas 634 as carbon dioxide 634C it is recycled back by extended recycle loop 637 to RWGS reactor 620 to continue the cycle. This advantageous cycle is a closed loop of carbon dioxide with no external carbon dioxide emissions. Given a sufficient amount of carbon dioxide 634C from top gas 634 being recycled by extended recycle loop 637 system 600 can reduce gas stream 618 from carbon dioxide source 616 (see FIG. 8A). It is apparent to one skilled in the art that in another embodiment both recycled carbon dioxide 634C and hydrogen 634A can be added to RWGS reactor 620 to avoid the separation of carbon dioxide 634C and hydrogen 634A.

In addition, system 600 is also equipped to take further advantage of thermal energy available from pyrolysis carbon product 611 separated in high-temperature carbon separation mechanism 612. For this purpose, system 600 has a heat exchanger 648 for transferring heat from pyrolysis carbon product 611 back to system 600. Specifically, heat available from passing pyrolysis carbon product 611 through heat exchanger 648 can be transferred to hydrocarbon feedstock 608 or to metal oxide 626. Alternatively or in addition, the heat can be transferred to a steam or a working fluid to be used in system 600. The mechanics of heat exchangers are well known to those skilled in the art.

Furthermore, system 600 is also equipped to take further advantage of thermal energy available from metal oxide reduction product 604 exiting through bottom furnace outlet 630 of DRI furnace 624. To accomplish this, system 600 has a heat exchanger 650 for transferring heat from metal oxide reduction product 604 back to system 600. In particular, heat available from metal oxide reduction product 604 is captured by a suitable fluid in heat exchanger 650. This captured heat can be transferred to hydrocarbon feedstock 608 or to metal oxide 626. Alternatively or in addition, the heat can be transferred to a steam or a working fluid to be used in system 600.

System 600 can also be provided with a control system analogous to the one described above in reference to FIG. 7B. Such control system can vary the ratio of hydrocarbon feedstock and carbon dioxide gas as well the pyrolyzation temperature and the shift temperature to provide control over a carbon composition and metallization factor of the metal oxide reduction product 604 obtained from DRI furnace 624.

It will be apparent to one skilled in the art that instead of DRI furnace 624 a blast furnace, a smelting furnace or still other system that uses reducing gas to chemically transform a metal oxide or other chemical system can be used. Also, there are many uses for syngas derived in accordance with the invention. These include chemical synthesis, power generation, fuel production and metal oxide reduction, as discussed in the above embodiment.

Traditional methods of producing potentially carbon-neutral methanol from syngas include combining water-electrolysis derived H₂ (eH₂) with waste CO₂ and then performing the RWGS reaction or electrochemically reducing CO₂ to CO (eCO) and combining with clean H₂. eH₂ is an electricity intensive process which requires ˜50 kWhe/kg-H₂. This hydrogen would then need to be mixed with CO₂ and heated to initiate the RWGS reaction, adding another 4-6 kWhe/kg-H₂ depending on the reaction temperature. The electrochemical reduction of CO₂ requires a similar reduction enthalpy to produce CO as it does to produce He from H₂O, making it also highly energy intensive.

In contrast, the thermally driven methane pyrolysis process of the present invention uses less than 25 kWhe/kg-H₂ and preferably less than 15 kWhe/kg-H₂ and potentially no additional heat needs to be input to drive the RWGS reaction to reduce waste CO₂ to CO. Thus, the integration presented herein could save over 4 times the electricity compared to the electrochemical eH₂ or eCO routes of producing syngas.

There are several important design considerations which must be taken into account: 1) high temperature solid carbon removal, 2) heating of CO₂ to over 800° C. and maintaining the reaction temperature despite the endothermic RWGS reaction, 3) high temperature catalyst stability, 4) materials of construction and sealing for operation at 900° C. to 1,100° C., and 5) ensuring a desirable syngas composition for methanol synthesis, free of compounds which could poison the catalyst.

First, the majority of the solid carbon produced during methane pyrolysis will ideally be separated in a high-temperature carbon separation mechanism to maintain the hydrogen gas at high temperature (1,200° C. to 1,400° C.). Any carbon not extracted will react with CO₂ at high temperatures according to the Boudouard reaction: C+CO₂→2CO, thus increasing the CO₂ intensity of the resulting methanol by introducing more fossil-based carbon into the methanol. This problem can be mitigated by using a series of cyclones, as mentioned above, to increase the capture efficiency of carbon particles and one can also blend in renewable natural gas or biomethane as hydrocarbon feedstock so that a portion of the solid carbon that passes through is actually from a biogenic source.

Second, it is important to control the shift temperature of the RWGS reaction, because methane and coke can be formed at temperatures between 600° C. and 800° C. In the present invention the RWGS reaction is run at shift temperatures above 800° C., and it utilizes the cold waste CO₂ gas to control the high Ho temperature. The incoming CO₂ gas will is preferably heat exchanged with output syngas stream to both cool down the outgoing syngas and heat up the CO₂ gas prior to entering the RWGS reactor. An increased reaction rate will mitigate the problems of endothermic cooling of the catalyst bed as the reaction proceeds.

Third, at the high temperatures herein, sintering of metallic catalysts can occur. This is a major problem with the typical low-temperature copper based catalysts. However, Wolf et al. demonstrated nearly 80% yield at 900° Cusing a commercial steam methane reforming catalyst of nickel-alumina. The alumina helps prevent the nickel from softening and sintering at high temperature, which reduces the active area of the catalysts, resulting in deactivation. The 80% yield may actually be beneficial for methanol production as Klier et al. found that small amounts (2-6 mol %) of CO₂ in the syngas mixture were necessary for methanol production because CO₂ maintains the catalyst in an intermediate oxidation state. To further avoid the problems of high temperature, in some embodiments, a catalyst does not need to be used if the shift temperature is sufficiently high, e.g., between 1,000° C. and 1,200° C.

Fourth, materials of construction are a major design constraint for high temperature operation. Graphite can be used when operating in high temperature and inert environments; however, graphite is not suitable when CO₂ is present as it would undergo the Boudouard reaction and form CO. Quenching the pyrolysis-derived H₂ at temperature with CO₂ to below 1,100° C. could enable the usage of inconel, which is stable to 1,100° C. But there are several nickel superalloys, described above, which can withstand temperatures up to 1,200° C. In the present invention, refractory lined stainless steel piping can be used for the heat exchange region between hot pyrolysis-derived H₂ and CO₂.

Fifth, it is important that there are no sulfur and chlorine compounds which can degrade the catalysts for subsequent downstream processes such as methanol synthesis and Fischer Tropsch reactors for the production of hydrocarbons

The final piece of full process integration in order to maximize energy efficiency and minimize the required electricity input is the utilization of waste heat. The primary inputs into the system are natural gas, electricity, and C₂ and the primary outputs are steam, hydrolysis carbon product, and syngas. Carbon product and syngas come out of the reactor at ˜600° C. to 1, 000° C. and thus have a large potential for heat exchange with the incoming hydrocarbon feedstock and CO, to decrease the electricity input for pre-heating. The pre-heating of hydrocarbon feedstock prior to pyrolysis is the final piece of integration to minimize electricity consumption. As shown above in the embodiment of FIG. 8B, heat exchangers can extract the sensible heat from the hot syngas and/or pyrolysis carbon product(s).

In some embodiments, it is simpler to use the waste heat from the hot syngas and pyrolysis carbon product to heat up steam in order to run a steam turbine to generate electrical power to run the process. The fraction of energy that can be recovered from a steam turbine will increase as the system size increases as turbine efficiency typically increases with increasing size. If the turbine efficiency can reach >35%, this method may compete with using the waste heat to heat up the incoming hydrocarbon feedstock.

A wide range of hydrocarbon feedstock conversions in the pyrolysis reactor and carbon separation efficiencies in the high-temperature carbon separation mechanism can be used to tune the syngas product and emissions of the furnace. Ideally, hydrocarbon feedstock to hydrogen conversion is as high as possible and pyrolysis carbon product separation is as high as needed to remove all carbon from the reducing pyrolysis gases stream. Even lower efficiencies (<70%) of hydrocarbon feedstock conversion to solid pyrolysis carbon product and hydrogen and carbon separation in the high-temperature carbon separation mechanism would function well in the present invention, although operating the system in this way would increase the overall system CO₂ emissions.

It will be evident to a person skilled in the art that the present invention admits of various other embodiments. Therefore, its scope should be judged by the claims and their legal equivalents.

1. A chemical system for producing a synthesis gas, said chemical system comprising:
a) a pyrolysis reactor for pyrolyzing a hydrocarbon feedstock into pyrolysis gases at a pyrolyzation temperature, said pyrolysis gases comprising a pyrolysis carbon product and a pyrolysis-derived hydrogen;
b) a high-temperature carbon separation mechanism for receiving said pyrolysis gases from said pyrolysis reactor and for separating said pyrolysis carbon product from said pyrolysis gases while maintaining said pyrolysis gases at a temperature above 800° C.;
c) a carbon dioxide source for providing a gas stream primarily comprising a carbon dioxide gas;
d) a reverse water gas shift reactor for:
1) receiving said pyrolysis gases from said high-temperature carbon separation mechanism;
2) receiving said gas stream from said carbon dioxide source;
3) reacting said pyrolysis gases with said gas stream to form said synthesis gas;
wherein said synthesis gas primarily comprises hydrogen and carbon monoxide and further comprises a mixture of carbon dioxide and water.

2. The chemical system of claim 1, wherein said hydrocarbon feedstock is selected from the group consisting essentially of methane, natural gas and said pyrolysis carbon product comprises solid carbon.

3. The chemical system of claim 1, wherein said pyrolyzation temperature is between 500° C. and 1,600° C.

4. The chemical system of claim 1, wherein said pyrolysis carbon product is fluidized out of said pyrolysis reactor by said pyrolysis gases.

5. The chemical system of claim 1, wherein a reaction yield of hydrocarbon feedstock to pyrolysis-derived hydrogen in said pyrolysis reactor is greater than 70%.

6. The chemical system of claim 1, wherein said high-temperature carbon separation mechanism has at least one element selected from among a high-temperature cyclone and a high-temperature candle filter.

7. The chemical system of claim 1, wherein said high-temperature carbon separation mechanism separates from said pyrolysis gases said pyrolysis carbon product at over 60% to over 90% by mass.

8. The chemical system of claim 1, wherein said carbon dioxide source is selected from among a biogenic carbon dioxide source and a3 waste carbon dioxide source.

9. The chemical system of claim 1, wherein said carbon dioxide gas is pre-heated to a temperature above 300° C. to above 500° C. prior to being received in said reverse water gas shift reactor.

10. The chemical system of claim 1, wherein said reverse water gas shift reactor is operated at a shift temperature above 800° C.

11. The chemical system of claim 1, wherein said reverse water gas shift reactor deploys a nickel-based catalyst.

12. The chemical system of claim 1, wherein said pyrolysis gases received from said high-temperature carbon separation mechanism are cooled in said reverse water gas shift reactor by said carbon dioxide gas to a temperature below 1,200° C.

13. The chemical system of claim 1, wherein said synthesis gas contains over 40% hydrogen by volume and over 15% carbon monoxide by volume.

14. The chemical system of claim 1, wherein said pyrolysis reactor is selected from among a thermal pyrolysis reactor, a microwave pyrolysis reactor, a plasma pyrolysis reactor, a liquid metal containing pyrolysis reactor, a liquid salt containing pyrolysis reactor and a catalytic pyrolysis reactor.

15. The chemical system of claim 1, further comprising a heat exchanger downstream from said reverse water gas shift reactor for transferring heat from said synthesis gas to said gas stream.

16. The chemical system of claim 1, further comprising a heat exchanger downstream from said reverse water gas shift reactor for transferring heat from said synthesis gas to said hydrocarbon feedstock.

17. The chemical system of claim 1, further comprising a wet scrubber system downstream from said reverse water gas shift reactor for removing contaminants from said synthesis gas.

18. The chemical system of claim 1, further comprising a removal system downstream from said reverse water gas shift reactor for removing at least a portion of said mixture of carbon dioxide and water from said synthesis gas, said removal system being at least one selected from among a flash separation system, a pressure swing adsorber system, a thermal swing adsorber system and dehydration and carbon dioxide removal system.

19. The chemical system of claim 1, further comprising a control system for:
a) varying a ratio of said hydrocarbon feedstock and said carbon dioxide gas in said gas stream;
b) varying said pyrolyzation temperature and a shift temperature in said reverse water gas shift reactor;
thereby providing control over relative composition of hydrogen, carbon monoxide, carbon dioxide and water in said synthesis gas.

20. A synthesis gas obtained in a reaction with pyrolysis gases, wherein said synthesis gas is obtained by a method comprising:
a) providing a pyrolysis reactor for pyrolyzing a hydrocarbon feedstock into said pyrolysis gases at a pyrolyzation temperature, said pyrolysis gases comprising a pyrolysis carbon product and a pyrolysis-derived hydrogen;
b) feeding said pyrolysis gases from said pyrolysis reactor to a high-temperature carbon separation mechanism for separating said pyrolysis carbon product from said pyrolysis gases while maintaining said pyrolysis gases at a temperature above 800° C.;
c) providing a gas stream primarily comprising a carbon dioxide gas from a carbon dioxide source;
d) providing a reverse water gas shift reactor for:
1) receiving said pyrolysis gases from said high-temperature carbon separation mechanism;
2) receiving said gas stream from said carbon dioxide source;
3) reacting said pyrolysis gases with said gas stream to form said synthesis gas;
wherein said synthesis gas primarily comprises hydrogen and carbon monoxide and further comprises a mixture of carbon dioxide and water.

21. A system for obtaining a synthesis gas and a metal oxide reduction product in a metal oxide reduction reaction with said synthesis gas, wherein said system comprises:
a) a pyrolysis reactor for pyrolyzing a hydrocarbon feedstock into pyrolysis gases at a pyrolyzation temperature, said pyrolysis gases comprising a pyrolysis carbon product and a pyrolysis-derived hydrogen;
b) a high-temperature carbon separation mechanism receiving said pyrolysis gases from said pyrolysis reactor and for separating said pyrolysis carbon product from said pyrolysis gases while maintaining said pyrolysis gases at a temperature above 800° C.;
c) a carbon dioxide source for providing a gas stream primarily comprising a carbon dioxide gas;
d) a reverse water gas shift reactor for:
1) receiving said pyrolysis gases from said high-temperature carbon separation mechanism;
2) receiving said gas stream from said carbon dioxide source;
3) reacting said pyrolysis gases with said gas stream to form said synthesis gas;
wherein said synthesis gas primarily comprises hydrogen and carbon monoxide and further comprises a mixture of carbon dioxide and water; and
e) a reduction furnace for receiving said synthesis gas and for running said metal oxide reduction reaction with a metal oxide and said synthesis gas.

22. The system of claim 21, wherein said high-temperature carbon separation mechanism has at least one element selected from among a high-temperature cyclone and a high-temperature candle filter.

23. The system of claim 22, wherein said high-temperature carbon separation mechanism separates from said pyrolysis gases said pyrolysis carbon product at over 60% to over 90% by mass.

24. The system of claim 21, further comprising a recycle loop for:
a) receiving a top gas from said reduction furnace;
b) drying said top gas; and
c) reinjecting said top gas into said system.

25. The system of claim 24, wherein said recycle loop further comprises a means for combusting said top gas to obtain high-temperature gases and said step of reinjecting comprises injection into said reduction furnace to add heat.

26. The system of claim 24, wherein said recycle loop reinjects said top gas into said synthesis gas for cooling before said reduction furnace receives said synthesis gas.

27. The system of claim 24, wherein said recycle loop purifies said top gas to remove at least one of particulate matter, carbon dioxide, non-reducing gasses.

28. The system of claim 21, wherein a portion of said synthesis gas is combusted prior to entering said reduction furnace to create a high-temperature synthesis gas for adding heat to said reduction furnace.

29. The system of claim 21, wherein said metal oxide reduction reaction is practiced with a metal oxide selected from the group consisting of iron ore, tin oxide, lead oxide, nickel oxide, copper oxide, and cobalt oxide.

30. The system of claim 21, further comprising a control system for:
a) varying a ratio of said hydrocarbon feedstock and said carbon dioxide gas in said gas stream;
b) varying said pyrolyzation temperature and a shift temperature in said reverse water gas shift reactor;
thereby providing control over a carbon composition and a metallization factor of said metal oxide reduction product exiting said reduction furnace.

31. The system of claim 21, further comprising a heat exchanger for transferring heat from said pyrolysis carbon product to at least one of said hydrocarbon feedstock, said metal oxide, a steam and a working fluid.

32. The system of claim 21, further comprising a heat exchanger for transferring heat from said metal oxide reduction product to at least one of said hydrocarbon feedstock, said metal oxide, a steam and a working fluid.
